(19) United States
(12) Patent Application Publication
(10) Pub. No.: US 2018/0239636 A1
(43) Pub. Date: Aug. 23, 2018

(54) TASK EXECUTION FRAMEWORK USING IDEMPOTENT SUBTASKS

(71) Applicant: Nutanix, Inc., San Jose, CA (US)

(72) Inventors: Abhishek Arora, San Jose, CA (US); Rahul Paul, Bangalore (IN)

(21) Appl. No.: 15/439,576

(22) Filed: Feb. 22, 2017

(51) Int. Cl. G06F 9/48; G06F 17/30

(52) U.S. Cl. CPC G06F 9/485; G06F 17/30312

(57) ABSTRACT

According to a first embodiment, a system for executing tasks is disclosed. The system includes a persistent storage device configured to store a task database, the task database comprising a plurality of tasks each having a plurality of associated subtasks and a task engine. The task engine is configured to execute a first idempotent operation associated with a first subtask of a first task to generate a first task state, associate the first task state with the first task in the task database, execute a second idempotent operation associated with a second subtask of the first task based on the first task state to generate a second task state, and associate the second task state with the first task in the task database.

### TECHNICAL HELD

This disclosure relates generally to computer task execution. Examples of task execution frameworks using idempotent subtasks are described.

### BACKGROUND

When a computer system (e.g. a process executing on a computer system) crashes and restarts, it may be desirable for the system to be able to resume operation without substantially interfering with user experience. Crashes may interrupt one or more tasks that are being executed by the computer system at the time of the crash. In many traditional computer systems, these tasks must be reinitiated from the beginning once the computer system reboots. This re-execution of tasks is inefficient from a computer resources standpoint, and may have adverse effects on user experiences as the user may need to wait for a period of time for the computing system to reestablish its conditions prior to the crash. In some scenarios, the user may be required to reenter information that was already provided to the computer system, causing user frustration at repeating their instructions. In some scenarios, the computer system may restart ineffectively, and rely on erroneous intermediate values to complete a task.

### SUMMARY

According to a first embodiment, a system for executing tasks is disclosed. The system includes a persistent storage device configured to store a task database, the task database comprising a plurality of tasks each having a plurality of associated subtasks and a task engine. The task engine is configured to execute a first idempotent operation associated with a first subtask of a first task to generate a first task state, associate the first task state with the first task in the task database, execute a second idempotent operation associated with a second subtask of the first task based on the first task state to generate a second task state, and associate the second task state with the first task in the task database.

According to another embodiment, a method for executing tasks is disclosed. the method includes polling a task database to identify a first task for execution, wherein the task database comprises a plurality of tasks each having a plurality of associated subtasks, executing a first idempotent operation associated with a first subtask of the first task to generate a first task state, associating the first task state with the first task in a task database, executing a second idempotent operation associated with a second subtask of the first task based on the first task state to generate a second task state, and associating the second task state with the first task in the task database.

According to yet another embodiment, a method of executing tasks is disclosed. The method includes initiating an instruction to execute a task, identifying a first subtask of the task, comparing a current task state associated with the task with a target state associated with the first subtask to determine whether the current task state matches the target state, responsive to determining that the current task state does not match the target state, executing a first operation associated with the first subtask to generate a new task state, responsive to determining that the current task state matches the target state, identifying by the processor, a second subtask of the task and executing a second operation associated with the second subtask to generate the new tasks state, and updating, by the processor, the current task state with the new task state.

### BRIEF DESCRIPTION OF THE DRAWINGS

FIG. 1 is a block diagram of a distributed computing system, in accordance with an embodiment of the present invention.

FIG. 2 is a block diagram of a computing system including a persistent task database, in accordance with an embodiment of the present invention.

FIG. 3 is a block diagram of a task entry in a task queue, in accordance with the embodiment of FIG. 2.

FIG. 4 is a flowchart illustrating a method of executing a task with idempotent operations, in accordance with an embodiment of the present invention.

FIG. 5 is a flowchart illustrating a method of executing a task with idempotent subtasks, in accordance with an embodiment of the present invention.

FIG. 6 is a block diagram of a computing node, in accordance with an embodiment of the present invention.

### DETAILED DESCRIPTION

Certain details are set forth below to provide a sufficient understanding of embodiments of the invention. However, it will be clear to one skilled in the art that embodiments of the invention may be practiced without one or more of these particular details. In some instances, computer system components, circuits, control signals, timing protocols, and software operations have not been shown in detail in order to avoid unnecessarily obscuring the described embodiments of the invention.

Embodiments disclosed herein may recognize the various shortcomings of previous task execution frameworks. Disclosed herein is a scalable task execution framework that allows for efficient recovery and resumption of task execution following a crash without the need to spend time and resources re-executing operations that have previously been completed. The disclosed systems may break tasks into subtasks that are associated with idempotent operations. Idempotent operations generally refer to operations which are structured such that once the operation has been performed on a given input, any additional executions of the operation will result in a same result. Thus, in the event that an idempotent operation is performed more than once, the result will not change following the first execution of the operation. Enforcing idempotency of operations may protect examples of the disclosed framework from producing undesired results, should an operation be inadvertently performed more than once.

The disclosed system may also implement a check-pointing system utilizing a persistent storage device. According to examples of the disclosed check-pointing system, the result of each idempotent operation may be immediately stored in a persistent storage device. That way, in the event of a crash, the system may immediately resume the task execution from the most recent checkpoint without unnecessarily re-executing operations that have previously been completed. Thus, examples of the disclosed systems and methods may, among other improvements, provide a task execution framework that implements a check-pointing system for efficient crash recovery, while using idempotent operations to ensure that repeated execution of operations do not result in unintended results.

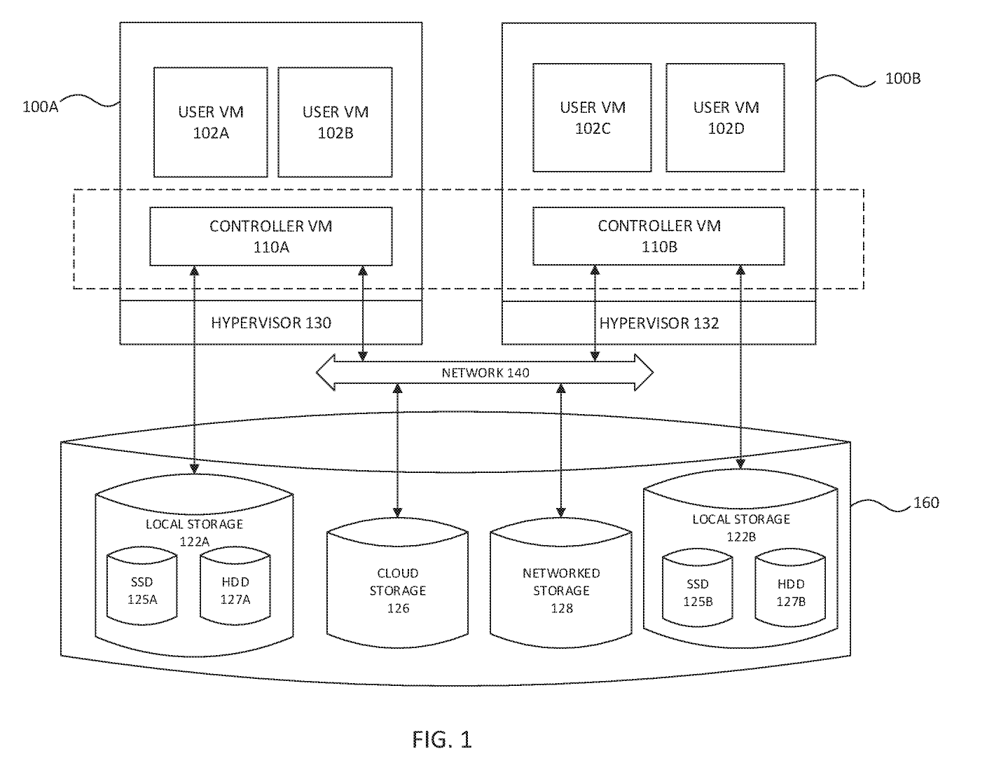

FIG. 1 is a block diagram of a distributed computing system, in accordance with an embodiment of the present invention. The distributed computing system of FIG. 1 generally includes computing nodes 100A, 100E and storage 160 connected to a network 140. The network 140 may be any type of network capable of routing data transmissions from one network device (e.g., computing nodes 100A, 100B and storage 160) to another. For example, the network 140 may be a local area network (LAN), wide area network (WAN), intranet, Internet, or a combination thereof. The network 140 may be a wired network, a wireless network, or a combination thereof.

The storage 160 may include local storage 122A, 122B, cloud storage 126, and networked storage 128. The local storage may include, for example, one or more solid state drives (SSD) 125A and one or more hard disk drives (HDD) 127A. Similarly, local storage 122B may include SSD 125B and HDD 127B. Local storages 122A, 122B may be directly coupled to, included in, and/or accessible by a respective computing node 100A, 100B without communicating via the network 140. Cloud storage 126 may include one or more storage servers that may be stored remotely to the computing nodes 100A, 100B and accessed via the network 140. The cloud storage 12.6 may generally include any type of storage device, such as HDDs SSDs, or optical drives. Networked storage 128 may include one or more storage devices coupled to and accessed via the network 140. The networked storage 128 may generally include any type of storage device, such as HDDs SSDs, or optical drives. In various embodiments, the networked storage 128 may be a storage area network (SAN).

The computing node 100A is a computing device for hosting VMs in the distributed computing system of FIG. 1. The computing node 100A may be, for example, a server computer, a laptop computer, a desktop computer, a tablet computer, a smart phone, or any other type of computing device. The computing node 100A may include one or more physical computing components, such as processors.

The computing node 100A is configured to execute a hypervisor 130, a controller VM 110A and one or more user VMs, such as user VMs 102A, 102B, The user VMs 102A, 102B are virtual machine instances executing on the computing node 100A. The user VMs 102A, 102B may share a virtualized pool of physical computing resources such as physical processors and storage (e.g., storage 160). The user VMs 102A, 102B may each have their own operating system, such as Windows or Linux.

The hypervisor 130 may be any type of hypervisor. For example, the hypervisor 130 may be ESX, ESX(i), Hyper-V, KVM, or any other type of hypervisor. The hypervisor 130 manages the allocation of physical resources (such as storage 160 and physical processors) to VMs (e.g., user VMs 102A, 102B and controller VM 110A) and performs various VM related operations, such as creating new VMs and cloning existing VMs. Each type of hypervisor may have a hypervisor-specific API through which commands to perform various operations may be communicated to the particular type of hypervisor. The commands may be formatted in a manner specified by the hypervisor-specific API for that type of hypervisor. For example, commands may utilize a syntax and/or attributes specified by the hypervisor-specific API,

The controller VM 110A may include a hypervisor independent interface software layer that provides a uniform API through which hypervisor commands may be provided. Throughout this disclosure, the terms “hypervisor independent” and “hypervisor agnostic” are used interchangeably and generally refer to the notion that the interface through which a user or VM interacts with the hypervisor is not dependent on the particular type of hypervisor being used. For example, the API that is invoked to create a new VM instance appears the same to a user regardless of what hypervisor the particular computing node is executing (e.g. an ESX(i) hypervisor or a Hyper-V hypervisor). The controller VM 110A may receive a command through its uniform interface (e.g., a hypervisor agnostic API) and convert the received command into the hypervisor specific API used by the hypervisor 130.

The computing node 100B may include user VMs 102A, 102B, a controller VM 110B, and a hypervisor 132. The user VMs 102A, 102B, the controller VM 110B, and the hypervisor 132 may be implemented similarly to analogous components described above with respect to the computing node 100A. For example, the user VMs 102C and 102D may be implemented as described above with respect to the user VMs 102A and 102B. The controller VM 110B may be implemented as described above with respect to controller VM 110A. The hypervisor 132 may be implemented as described above with respect to the hypervisor 130. In the embodiment of FIG. 1, the hypervisor 132 may be a different type of hypervisor than the hypervisor 130. For example, the hypervisor 132 may be Hyper-V, while the hypervisor 130 may be ESX(i). The controller VMs 110A, 11.0B may communicate with one another via the network 140. By linking the controller VMs 110A, 110B together via the network 140, a distributed network of computing nodes 1.00A, 100B, each of which is executing a different hypervisor, can be created, The controller VMs 110A and 110B may execute a task engine configured to execute one or more tasks having idempotent subtasks.

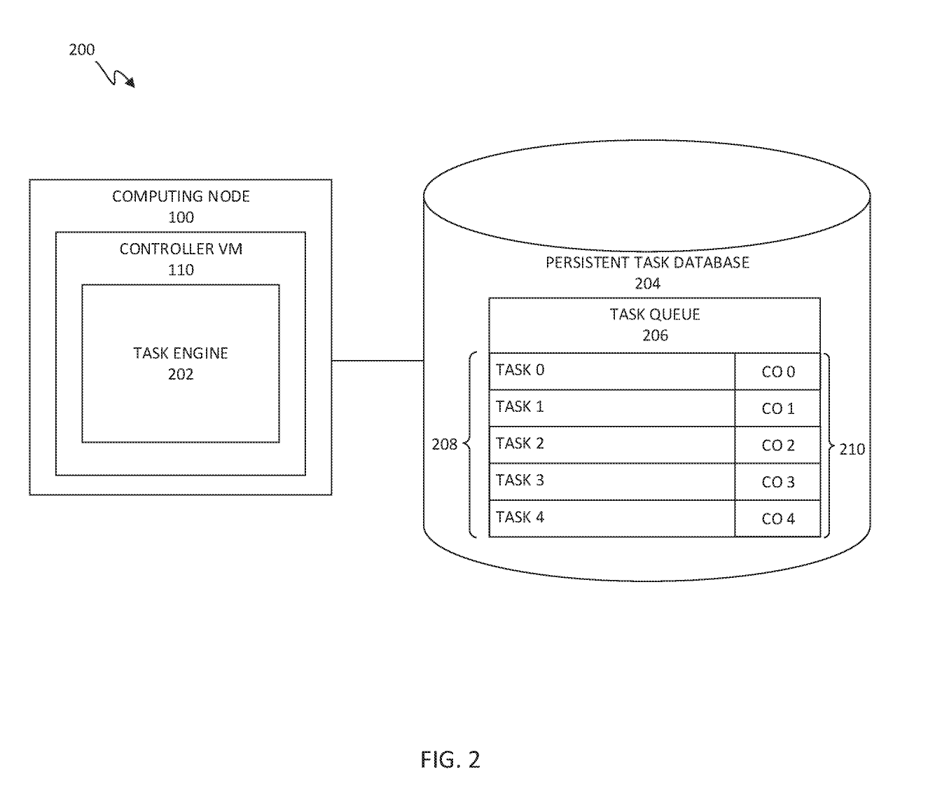

FIG. 2 is a block diagram of a computing system, generally designated 200, including a persistent task database, in accordance with an embodiment of the present invention. The computing system 200 includes the computing node 100 executing the controller VM 110 of FIG. 1 and a persistent task database 204. The persistent task database 204 may be stored on one or more of local storage 122A/122B, cloud storage 126, and/or networked storage 128.

The controller VM 110 may execute a task engine 202. The task engine 202 may include software, hardware, firmware, or a combination thereof that is configured to perform one or more tasks including idempotent subtasks. The task engine 202 may include, for example, one or more processors executing program instructions to perform tasks. Tasks that the task engine 202 may be configured to perform may include, but are not limited to, creating a VM, deleting a VM, adding virtual processors to a VM, deleting virtual processors from a VM, adding virtual memory to a VM, deleting virtual memory from a VM. In general, any task may be implemented as tasks for the task engine 202 to complete.

The persistent task database 204 may store a task queue 206. The task queue 206 may be a data structure, such as a queue, a list, a stack, etc. configured to store a plurality of pending tasks 208 for completion. The tasks 208 may include instructions for completing the tasks and may be divided into one or more idempotent sub tasks for execution by the task engine 202. Although five tasks are shown in FIG. 2, it should be appreciated that the task queue 206 may have any number of tasks stored therein. Each task may have an associated client object 210. The client objects 210 may generally be any type of objects, such as strings. The client objects 210 may include a current state of the task as well as defining one or more target task states for the associated tasks 208. Each task 208 may be divided into a plurality of subtasks. The target task states may be intermediate states resulting from the execution by the task engine 202 of idempotent operations associated with the subtasks of a given task. The target task states may provide a plurality of checkpoints against which the current state of the task may be compared to determine the next subtask operation to be performed by the task engine 202. Thus, the target states may enable the task engine to recover from an interruption, such as an unexpected restart, and to resume the task from the most recently completed subtask.

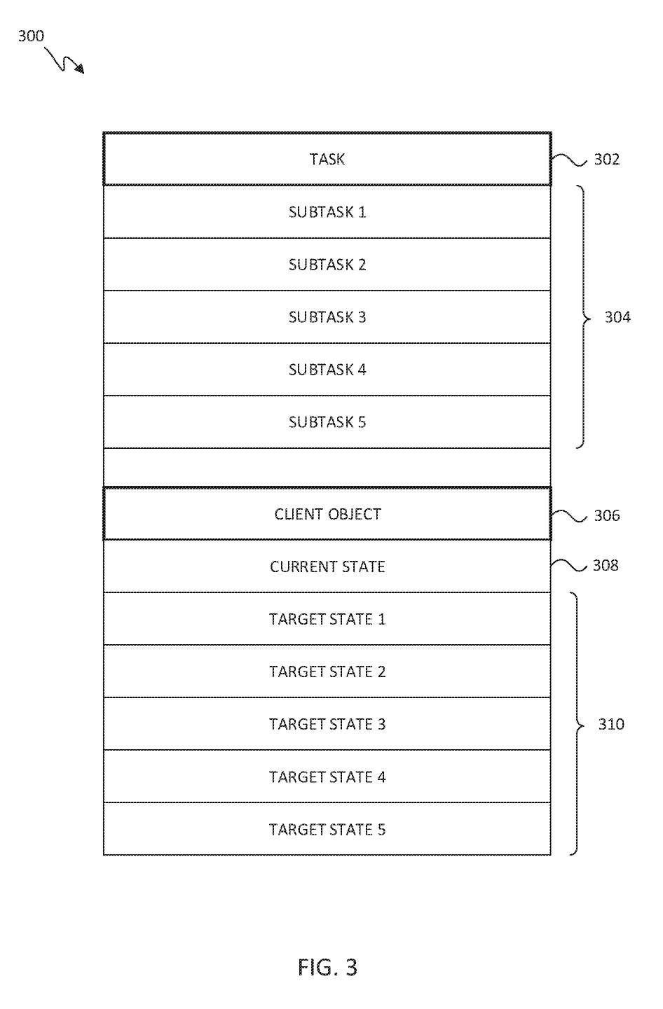

FIG. 3 is a block diagram of a task entry, generally designated 300, in the task queue 206, in accordance with the embodiment of FIG. 2. The task entry 300 may include a task 302 and a client object 306. The task 302 may be implemented as any of the tasks 208 of FIG. 2. The task 302 may generally define a goal of the task or an end state following completion of the task by the task engine 202. For example, an example task 302 may be to “add 500 MB of virtual memory to a virtual machine.” The task 302 may include a plurality of subtasks 304. Each subtask may include instructions to perform an idempotent operation on a current task state, For example, in the example of adding 500 MB of memory, the task 302 may include the following subtasks: (1) determine a current amount of memory for the VM, (2) calculate the result of (1) plus 500 MB, and (3) set the amount of memory for the VM to result in (2). Each of these idempotent subtasks may be embodied as program instructions to perform an operation or a series of operations.

The client object 306 may include a current state 308 and a plurality of target states 310. The current state 308 may be a data field that records a particular state or value indicative of the most recently completed subtask 304 in the task 302. The current state 308 may be updated following the completion of each idempotent operation(s) for each subtask to ensure that the progress of the task engine 202 in completing the task 302 regularly recorded in the persistent task database 204, allowing for efficient resumption of the task 302 should execution of the task 302 be interrupted for any reason. The target states 310 may be data fields defining the expected state following completion of an associated subtask 304. For example, in the embodiment of FIG. 3, the target state 1 may be associated with the subtask 1, the target state 2 may be associated with the subtask 2, etc. In the example discussed above regarding adding 500 MB of memory, the target state associated with subtask (1) may be, for example, 1 GB. The target state associated with subtask (2) may be 1.5 GB. The target state associated with the subtask (3) may be a VM with 1.5 GB of memory assigned to the VM. By determining what the target state 310 of each subtask 304 are prior to completing each subtask 304, the current state 308 may be compared to the target states 310 to determine what the most recently completed subtask 304 is and move to the next subtask 304 for the task engine 202 to complete. For example, if, during the addition of 500 MB of memory to the VM, the computing node 100 unexpectedly restarts after computing the result of subtask (2), the task engine 202 may compare the current state 308 (which has a value of 1.5 GB) to the target states 310, determine a matching target state, and proceed to execute the next subtask (subtask (3) in this example).

The task execution framework disclosed herein may be implemented as a centralized service that can be used by various users, processes, and/or VMs. For example, individual processes, VMs, and/or users may define their own tasks by defining idempotent subtasks for their tasks. The idempotent subtasks may then be uploaded to the persistent task database 204 for execution by the task engine 202. Thus, individual users/processes would not need to individually define their own tasks, but may simply define the component idempotent subtasks for the task.

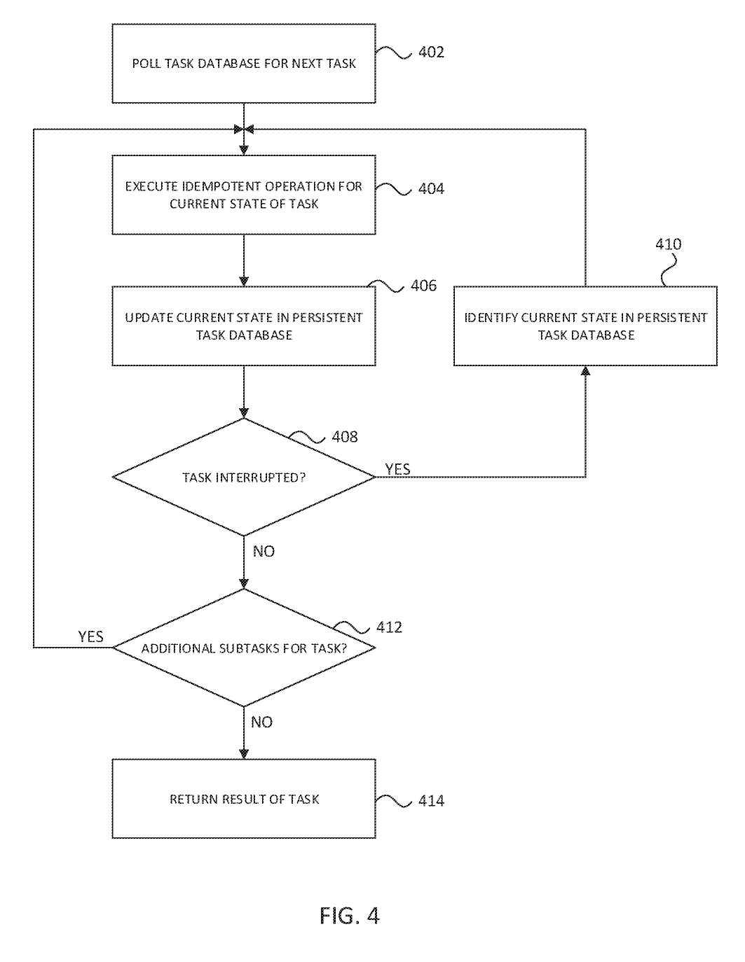

FIG. 4 is a flowchart illustrating a method of executing a task with idempotent operations, in accordance with an embodiment of the present invention. In operation 402, the task engine 202 may poll the persistent task database 204 for the next task to be completed. For example, the task engine may request the next task in the task queue 206. In general, the tasks 208 in the task queue 206 may be executed in any order. For example, the tasks 208 may be executed according to a first-in-first-out scheme, a first-in-last-out scheme, or any other type of scheme. In some embodiments, the tasks 208 may be executed in an interleaved manner, where some tasks are partially completed, another task is partially or wholly completed, and then the task engine 202 returns to complete the initial task. This execution scheme may be possible because the current state 308 of each task is committed to the persistent task database 204 following the completion of each subtask 304.

In operation 404, the task engine 202 executes an idempotent operation for the current state of the task. For example, the task engine may determine what the current state 308 of the task 302 is and identify the associated target state 310 by comparing the current state 308 to each target state 310. Once a match between the current state 308 and the target state 310 is found, the task engine may complete the idempotent operation associated with the subtask 304 for the next target state 310.

In operation 406, the task engine 202 may update the current state 308 in the persistent task database 204. For example, the task engine 202 may save or commit the result of operation 404 to the current state 308 data field in the task queue 206. Updating the current state 308 may include submitting, by the task engine 202, a write instruction to the persistent task database 204. to overwrite the existing value in the current state 308 with the newly calculated result of the idempotent operation performed in operation 404.

In operation 408, the task engine 202 may determine whether the task 302 was interrupted. For example, the computing node 100 executing the task engine 202. may unexpectedly restart, or the task engine 202 may be moved to a different computing node 100. The task engine 202 may be enabled to detect when such events occur. If the task engine 202 determines that the task was interrupted (decision block 408, YES branch), then the task engine identifies the current state 308 in the persistent task database 204 in operation 410. The task engine may submit a query to the persistent task database 204 to determine the current state 308 of the task 302. The task engine 202 may then execute an idempotent operation for the current state 308 of the task 302 in operation 404, as described above.

If the task engine 202 does not detect that the task was interrupted (decision block 408, NO branch), then the task engine 202 may determine whether there are additional subtasks 304. for the task 302 in operation 412. For example, the task engine 202 may access the task queue 206 in the persistent task database 204 and determine whether the current state 308 matches the final target state 310 for the task. If the task engine 202 determines that the current 308 state does not match the final target state 310, then there may be additional subtasks 304 that need to be performed for the task 302. If the task engine 202 determines that there are additional subtasks 304 for the task 304 (decision block 412, YES branch), then the task engine 202 may execute an idempotent operation for the current state 308 of the task 302 in operation 404, as described above.

If the task engine 202 determines that there are no additional subtasks 304 for the task 304 (decision block 412, NO branch), then the task engine may return the result of the task 302 and remove the task from the task queue 206 in operation 414. Returning the result of the task may include, for example, transmitting a confirmation message that the task was completed, launching a VM, or any other operation associated with the completion of a given task.

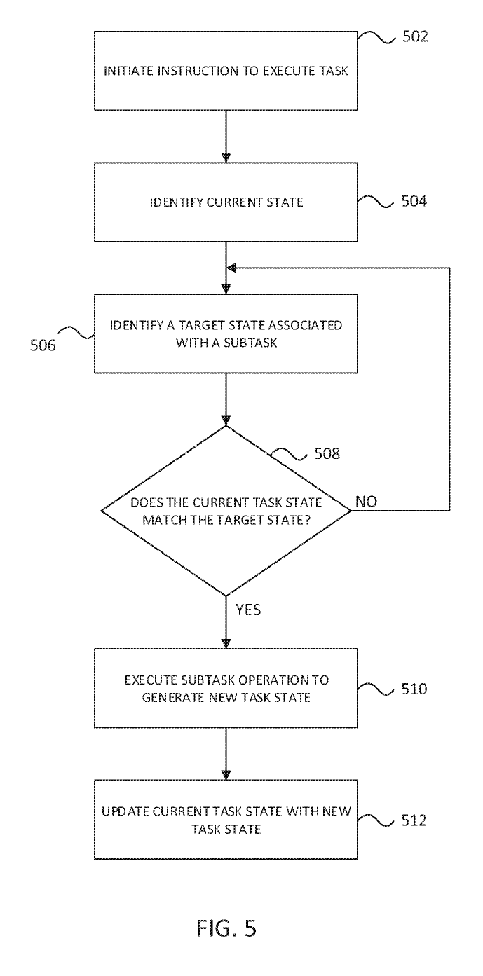

FIG. 5 is a flowchart illustrating a method of executing a task with idempotent subtasks, in accordance with an embodiment of the present invention. In operation 502, the task engine 202 initiates an instruction to execute a task 302. The instruction may include, for example, a user instruction to perform the task 302 or a poll operation to the task queue 206, as described above with respect to operation 402 of FIG. 4. In one embodiment, the task engine 202 detects an interruption in task execution. For example, the task engine 202 may determine that the computing node 100 has restarted following a power loss, or the task engine 202 may determine that the controller VM 110 has been migrated to a new computing node 100.

In operation 504, the task engine 202. may identify the current state 308 of the task 302. For example, the task engine 202 may submit a query to the persistent task database 204 and request the current state 308. The persistent task database 204 may return the requested current state 308 to the task engine 202.

In operation 506, the task engine 202 may identify a target state 310 associated with a subtask 304. For example, the task engine may submit a query to the persistent task database 204 to retrieve a target state 310 from the persistent task database 204. In some embodiments, such as when the task engine recovers from an unexpected interruption or restart, the task engine 202 may not know exactly which target state 310 to retrieve. In such embodiments, the task engine 202 may retrieve the target state 310 that corresponds to the first subtask 304 of the task 302. For example, in the embodiment of FIG. 3, the task engine 202 may retrieve the target state 1.

In operation 508, the task engine 202 may determine whether the current state 308 matches the identified target state 310. The task engine may compare the current state 308 as determined in operation 504 with the target state 310 as determined in operation 506 to determine if the two states are the same. If the task engine 202 determines that the current state 308 does not match the target state 310 (decision block 508, NO branch), then the task engine 202 may identify a new target state 310 in operation 506. For example, the task engine 202 may retrieve the next target state 310 from the persistent task database 204. By iteratively retrieving a new target state 310 from the persistent task database after each failure to match the target state 310 to the current state 308, the task engine 202 may determine the target state 310 that matches the current state 308 even when the correct target state 310 is unknown.

If the task engine 202 determines that the current state 308 matches the target state 310 identified in operation 506 (decision block 508, YES branch), then the task engine 202 may execute a subtask operation to generate a new task state in operation 510. For example, once the target state 310 that matches the current state 308 has been identified in operation 508, the task engine 202 may determine the subtask 304 that corresponds to the current state 308 and perform the next subtask 304 to generate the new task state. For example, the task engine may determine that the current state matches target state 2 in FIG. 3. The task engine 202 may then determine that the target state 2 corresponds to the completed state of subtask 2. That is, once the task engine has executed subtask 2, the result matches the target state 2. The task engine 202 may then proceed to perform an idempotent operation or operations that correspond to the next subtask in order to generate a new task state. In this example, the next subtask is subtask 3 and the new task state corresponds to the result of the idempotent operations associated with subtask 3.

In operation 512, the task engine may update the current task 308 with the new task state. For example, the task engine 202 may submit a write request to the persistent task database 204 with an instruction to overwrite the value stored in the current state 308 with the value generated in operation 510. This may ensure that the current state 308 is always reflective of the most recently completed subtask 304 associated with the task 302.

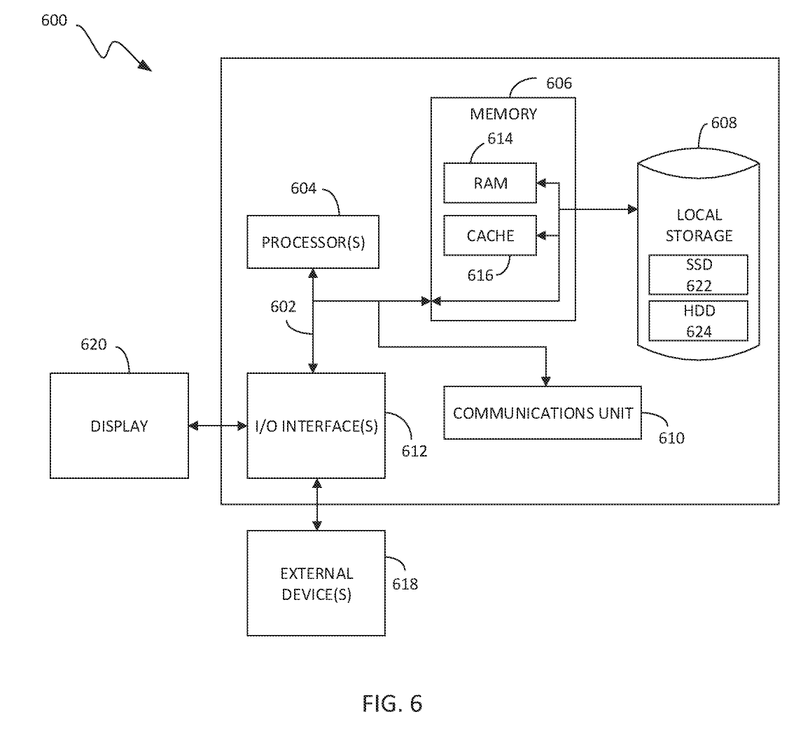

FIG. 6 depicts a block diagram of components of a computing node 600 in accordance with an embodiment of the present invention. It should be appreciated that FIG. 6 provides only an illustration of one implementation and does not imply any limitations with regard to the environments in which different embodiments may be implemented. Many modifications to the depicted environment may be made. The computing node 600 may implemented as the computing nodes 100A, and/or 100B.

The computing node 600 includes a communications fabric 602, which provides communications between one or more computer processors 604, a memory 606, a local storage 608, a communications unit 610, and an input/output (I/O) interface(s) 612. The communications fabric 602 can be implemented with any architecture designed for passing data and/or control information between processors (such as microprocessors, communications and network processors, etc.), system memory, peripheral devices, and any other hardware components within a system. For example, the communications fabric 602 can be implemented with one or more buses.

The memory 606 and the local storage 608 are computer-readable storage media. In this embodiment, the memory 606 includes random access memory (RAM) 614 and cache memory 616. In general, the memory 606 can include any suitable volatile or non-volatile computer-readable storage media. The local storage 608 may be implemented as described above with respect to local storage 122A, 122B. In this embodiment, the local storage 608 includes an SSD 622 and an HDD 624, which may be implemented as described above with respect to SSD 125A, 125B and HDD 127A, 127B, respectively.

Various computer instructions, programs, files, images, etc. may be stored in local storage 608 for execution by one or more of the respective computer processors 604 via one or more memories of memory 606. In some examples, local storage 608 includes a magnetic hard. disk drive 624. Alternatively, or in addition to a magnetic hard disk drive, local storage 608 can include the solid state hard drive 622, a semiconductor storage device, a read-only memory (ROM), an erasable programmable read-only memory (EPROM), a flash memory, or any other computer-readable storage media that is capable of storing program instructions or digital information.

The media used by local storage 608 may also be removable. For example, a removable hard drive may be used for local storage 608. Other examples include optical and magnetic disks, thumb drives, and smart cards that are inserted into a drive for transfer onto another computer-readable storage medium that is also part of local storage 608.

Communications unit 610, in these examples, provides for communications with other data processing systems or devices. In these examples, communications unit 610 includes one or more network interface cards. Communications unit 610 may provide communications through the use of either or both physical and wireless communications links.

I/O inteiface(s) 612 allows for input and output of data with other devices that may be connected to computing node 600. For example, I/O interface(s) 612 may provide a connection to external devices 618 such as a keyboard, a keypad, a touch screen, and/or some other suitable input device. External devices 618 can also include portable computer-readable storage media such as, for example, thumb drives, portable optical or magnetic disks, and memory cards. Software and data used to practice embodiments of the present invention can be stored on such portable computer-readable storage media and can be loaded onto local storage 608 via I/O interface(s) 612. I/O interface(s) 612 also connect to a display 620.

Display 620 provides a mechanism to display data to a user and may be, for example, a computer monitor.

The programs, operations, methods, and systems described herein are identified based upon the application for which they are implemented in a specific embodiment of the invention. However, it should be appreciated that any particular program nomenclature herein is used. merely for convenience, and thus the invention should not be limited to use solely in any specific application identified and/or implied by such nomenclature.

Those of ordinary skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Skilled artisans may implement the described functionality in varying ways for each particular application and may include additional operational steps or remove described operational steps, but such implementation decisions should not be interpreted as causing a departure from the scope of the present disclosure as set forth in the claims.

What is claimed is:

1. A system for executing tasks, the system comprising:
a persistent storage device configured to store a task database, the task database comprising a plurality of tasks each having a plurality of associated subtasks; and
a task engine configured to:
execute, by a processor, a first idempotent operation associated with a first subtask of a first task to generate a first task state;
associate, by the processor, the first task state with the first task in the task database;
execute, by the processor, a second idempotent operation associated with a second subtask of the first task based on the first task state to generate a second task state; and
associate, by the processor, the second task state with the first task in the task database.

2. The system of claim 1, wherein the task engine is further configured to:
detect, by the processor, an interruption in execution of the first task following associating the first task state with the first task and prior to executing the second idempotent operation; and
responsive to detecting the interruption, retrieve the first task state from the task database.

3. The system of claim 1, wherein the task engine is further configured to:
determine whether a third idempotent operation is associated with the first task;
responsive to determining that the third idempotent operation is associated with the first task, execute, by the processor, the third idempotent operation to generate a third task state; and
associate, by the processor, the third task state with the first task in the task database.

4. The system of claim 1, wherein the task engine is further configured to:
determine whether a third idempotent operation is associated with the first task;
responsive to determining that a third idempotent operation is not associated with the first task, returning, by the processor, a result of the second idempotent operation.

5. The system of claim 1, wherein the plurality of tasks are stored in the task database in a queue data structure.

6. The system of claim 1, wherein the task engine is further configured to:
poll, by the processor, the task engine to identify a task for executed; and
retrieve, by the processor, the identified task from the task database.

7. The system of claim 1, wherein each task of the plurality of tasks is associated with an object in the task database, wherein the object defines a target task state for each subtask of the plurality of subtasks.

8. A method for executing tasks, the method comprising:
polling, by a processor, a task database to identify a first task for execution, wherein the task database comprises a plurality of tasks each having a plurality of associated subtasks;
executing, by the processor, a first idempotent operation associated with a first subtask of the first task to generate a first task state;
associating, by the processor, the first task state with the first task in a task database;
executing, by the processor, a second idempotent operation associated with a second subtask of the first task based on the first task state to generate a second task state; and
associating, by the processor, the second task state with the first task in the task database.

9. The method of claim 8, further comprising:
detecting, by the processor, an interruption in execution of the first task following associating the first task state with the first task and prior to executing the second idempotent operation; and
responsive to detecting the interruption, retrieving, by the processor, the first task state from the task database.

10. The method of claim 8, further comprising:
determining, by the processor, whether a third idempotent operation is associated with the first task;
responsive to determining that the third idempotent operation is associated with the first task, executing, by the processor, the third idempotent operation to generate a third task state; and
associating, by the processor, the third task state with the first task in the task database.

11. The method of claim 8, further comprising:
determining, by the processor, whether a third idempotent operation is associated with the first task;
responsive to determining that the third idempotent operation is not associated with the first task, returning, by the processor, a result of the second idempotent operation.

12. The method of claim 8, wherein the plurality of tasks are stored in the task database in a queue data structure.

13. The method of claim 8, wherein each task of the plurality of tasks is associated with an object in the task database, wherein the object defines a target task state for each subtask of the plurality of subtasks.

14. A method for executing a task, the method comprising:
initiating, by a processor, an instruction to execute a task;
identifying, by the processor, a first subtask of the task;
comparing, by the processor, a current task state associated with the task with a target state associated with the first subtask to determine whether the current task state matches the target state;
responsive to determining that the current task state does not match the target state, executing, by the processor, a first operation associated with the first subtask to generate a new task state;
responsive to determining that the current task state matches the target state:
identifying by the processor, a second subtask of the task; and
executing, by the processor, a second operation associated with the second subtask to generate the new tasks state, and
updating, by the processor, the current task state with the new task state.

15. The method of claim 14, wherein initiating the instruction to execute the task comprises:
polling, by the processor, a task database configured to store a plurality of tasks to identify the task.

16. The method of claim 15. wherein the current task state is stored in the task database in association with the task.

17. The method of claim 14, wherein the task comprises a plurality of subtasks, each subtask having an associated target state.

18. The method of claim 17, wherein each subtask is associated with an operation, and execution of each operation results in the associated target state of a respective subtask.

19. The method of claim 18, wherein the operation is an idempotent operation.

20. The method of claim 14, further comprising:
detecting, by the processor, an interruption in execution of the task;
determining, by the processor, that the current task state has been overwritten with the new ask state;
identifying by the processor, a third subtask of the task;
executing, by the processor, a third operation associated with the third subtask to generate a second new task state; and
overwriting the new task state with the second new task state.
